(19) United States
(12) Patent Application Publication
(10) Pub. No.: US 2026/0351668 A1
(43) Pub. Date: Nov. 5, 2026

(54) METHOD FOR PRODUCING GARNET-TYPE OXIDE SOLID ELECTROLYTE

(71) Applicant: JTEKT CORPORATION, Kariya-shi, Aichi (JP)

(72) Inventors: Masahiro SUZUKI, Kashiba-shi (JP); Hajime MATSUMOTO, Ikeda-shi (JP)

(73) Assignee: JTEKT CORPORATION, Kariya-shi, Aichi (JP)

(21) Appl. No.: 19/125,453

(22) PCT Filed: Dec. 29, 2022
(86) PCT No.: PCT/JP2022/048705

§ 371 Date: Apr. 29, 2025

(51) Int. Cl. H01M 10/0562

(52) U.S. Cl. CPC H01M 10/0562; H01M 2300/0077

(57) ABSTRACT

A method for producing a garnet-type oxide solid electrolyte includes: obtaining an intermediate by pressure molding of Li₇La₃Zr₂O₁₂ powder having a median diameter (D50) of 0.02 to 0.2 μm; and obtaining a first garnet-type oxide solid electrolyte by heating the intermediate at 1050 to 1150 °C for 1 to 3 hours and then cooling the intermediate to room temperature within 1 hour.

### TECHNICAL FIELD

The present disclosure relates to a method for producing a garnet-type oxide solid electrolyte.

### BACKGROUND ART

In recent years, all-solid-state batteries have been proposed as next-generation batteries for automobiles and electronic devices. The all-solid-state battery is a secondary battery in which a solid electrolyte is interposed between a cathode and an anode. Known solid electrolytes for use in all-solid-state batteries include sulfide-based solid electrolytes and oxide-based solid electrolytes. In general, sulfide-based solid electrolytes are softer than oxide-based solid electrolytes, and therefore have lower interface resistance and higher ionic conductivity. However, sulfide-based solid electrolytes have lower chemical stability than oxide-based solid electrolytes. If the sulfide-based solid electrolytes come into contact with air, hydrogen sulfide gas is generated. Oxide-based solid electrolytes have higher chemical stability than sulfide-based solid electrolytes, but it is difficult to reduce the interface resistance because the oxide-based solid electrolytes are hard. Therefore, the oxide-based solid electrolytes have low ionic conductivity.

Examples of the oxide-based solid electrolytes include perovskite-type La₁₋₃ₓLi₃ₓTiO₃, NASICON-type Li₁₊ₓAlₓTi₂₋ₓ(PO₄)₃, and garnet-type Li₇La₃Zr₂O₁₂ (hereinafter sometimes referred to as “LLZO”). LLZO has high stability against lithium metal and is considered to be promising as an oxide-based solid electrolyte for all-solid-state batteries. However, LLZO has a property that lithium carbonate is easily formed on the surface. The lithium carbonate formed on the surface of LLZO increases the interface resistance of the garnet-type oxide solid electrolyte. The increase in the interface resistance causes a decrease in ionic conductivity. Patent Document 1 discloses a method for reducing the interface resistance by polishing the garnet-type oxide solid electrolyte to remove lithium carbonate formed on the surface.

### RELATED ART DOCUMENTS

### Patent Documents

Patent Document 1: Japanese Unexamined Patent Application Publication No. 2020-205284 (JP 2020-205284 A)

### SUMMARY OF THE INVENTION

A method for producing a garnet-type oxide solid electrolyte according to one aspect of the present disclosure includes:
obtaining an intermediate by pressure molding of Li₇La₃Zr₂O₁₂ (LLZO) powder having a median diameter (D50) of 0.02 to 0.2 μm; and
obtaining a first garnet- type oxide solid electrolyte by heating the intermediate at 950 to 1050 °C for 1 to 3 hours and then cooling the intermediate to room temperature within 1 hour.

### BRIEF DESCRIPTION OF THE DRAWINGS

FIG. 1 is a graph showing the relationship between a heating temperature in a heating/cooling step in which a cooling time is 4 hours (4 hours or more) and ionic conductivity in garnet-type oxide solid electrolytes made of LLZO powders having different median diameters (D50).

FIG. 2 is a graph showing the relationship between the heating temperature in the heating/cooling step in which the cooling time is 1 hour (1 hour or less) and the ionic conductivity in garnet-type oxide solid electrolytes made of LLZO powders having different median diameters (D50).

### MODES FOR CARRYING OUT THE INVENTION

### Problems to be Solved by Disclosed Invention

As described above, the oxide-based solid electrolyte has lower ionic conductivity than the sulfide-based solid electrolyte. Further, the ionic conductivity of the garnet-type oxide solid electrolyte decreases due to lithium carbonate etc. formed on the surface. Therefore, there is a demand for a method for producing a garnet-type oxide solid electrolyte having high ionic conductivity.

The method disclosed in Patent Document 1 is a method for increasing the ionic conductivity of a garnet-type oxide solid electrolyte by removing lithium carbonate formed on the surface of the garnet-type oxide solid electrolyte by a polishing process. However, it is difficult to apply the polishing method described in Patent Document 1 to a garnet-type oxide solid electrolyte having an undulating surface. Therefore, when the above polishing process is applied, the shape of the garnet-type oxide solid electrolyte to be produced is limited. Thus, there is a demand for a method for producing garnet-type oxide solid electrolytes with which impurities such as lithium carbonate can easily be removed from garnet-type oxide solid electrolytes having various shapes.

### Effects of Disclosed Invention

The invention of the present disclosure provides a method for producing a garnet-type oxide solid electrolyte that can easily be applied to garnet-type oxide solid electrolytes having various shapes and with which a garnet-type oxide solid electrolyte having high ionic conductivity can be produced.

### Outlines of Embodiment of Disclosed Invention

Outlines of an embodiment of the invention of the present disclosure will be listed below. (1 ) The method for producing a garnet-type oxide solid electrolyte according to the present disclosure includes:
obtaining an intermediate by pressure molding of Li₇La₃Zr₂O₁₂ (LLZO) powder having a median diameter (D50) of 0.02 to 0.2 μm; and
obtaining a first garnet-type oxide solid electrolyte by heating the intermediate at 1050 to 1150 °C for 1 to 3 hours and then cooling the intermediate to room temperature within 1 hour.

With the production method according to (1 ), it is possible to produce garnet-type oxide solid electrolytes having high ionic conductivity and various shapes.

(2) The production method according to (1 ) includes obtaining a second garnet-type oxide solid electrolyte by bringing at least one selected from an organic plastic ionic crystal and an ionic liquid into contact with the first garnet-type oxide solid electrolyte.

With the production method according to (2), it is possible to produce the second garnet-type oxide solid electrolyte having higher ionic conductivity.

(3) In the production method according to (1 ) or (2), the intermediate is obtained by the pressure molding of the LLZO powder under a condition of 72 MPa or more.

In the production method according to (3), the hardness of the intermediate can be secured sufficiently. Therefore, the shape of the intermediate can be maintained.

### Details of Embodiment of Disclosed Invention

Hereinafter, the embodiment of the present disclosure will be described.

It should be understood that the embodiment of the invention in the present disclosure is illustrative in all respects and not restrictive. The scope of the present invention is defined by the claims, and is intended to include all modifications within the meaning and scope equivalent to the claims.

The method for producing a garnet-type oxide solid electrolyte according to the present disclosure includes:
1) a pressure molding step for obtaining an intermediate by pressure molding of Li₇La₃Zr₂O 12 (LLZO) powder having a median diameter (D50) of 0.02 to 0.2 μm; and
2) a heating/cooling step for obtaining a first garnet-type oxide solid electrolyte by heating the intermediate at 1050 to 1150 °C for 1 to 3 hours and then cooling the intermediate to room temperature within 1 hour.

The method further includes
3) a contact step for obtaining a second garnet-type oxide solid electrolyte by bringing at least one selected from an organic plastic ionic crystal and an ionic liquid into contact with the first garnet-type oxide solid electrolyte.
1) The pressure molding step, 2) the heating/cooling step, and 3) the contact step will be described below in sequence.

### 1 ) Pressure Molding Step

First, the method for producing a garnet-type oxide solid electrolyte according to the present disclosure includes obtaining an intermediate by pressure molding of LLZO powder having a median diameter (D50) of 0.02 to 0.2 μm. The median diameter (D50) is a value measured by a laser diffraction/scattering method in conformity with JIS Z 8825: 2013.

The above LLZO powder having the median diameter (D50) of 0.02 to 0.2 μm may be commercially available LLZO powder or LLZO powder prepared to have the above predetermined median diameter by pulverizing LLZO powder having a median diameter (D50) of more than 0.2 μm. The LLZO powder may be pulverized by any known method without particular limitation. Specific examples of the pulverization method include a pulverization method using a bead mill, a ball mill, or a jet mill. The LLZO powder having the above predetermined median diameter can be obtained, for example, by pulverizing commercially available LLZO powder having a median diameter (D50) of more than 0.2 μm in isopropanol using a bead mill to obtain an isopropanol suspension and then removing isopropanol from the isopropanol suspension using an evaporator.

The above pressure molding may be any known pressure molding for use in the production of solid electrolytes, and is not particularly limited. An example of a process including known pressure molding is a process in which LLZO powder having the above predetermined median diameter is charged into a powder molding machine and then uniaxial pressure molding is performed using a hydraulic press. In the uniaxial pressure molding, the pressure to obtain the LLZO powder intermediate is preferably 72 MPa or more. The intermediate obtained by the pressure molding under the condition of 72 MPa or more has sufficient hardness. The pressure to obtain the LLZO powder intermediate may be any pressure as long as it is high. The upper limit of the pressure to obtain the LLZO powder intermediate is limited to an upper limit of the pressure that can be applied by a pressurizing device for use in the hydraulic press, and is, for example, 650 MPa but may be higher. Thus, the shape of the intermediate can be maintained throughout the subsequent heating/cooling step and the subsequent contact step described later.

### 2) Heating/cooling Step

The method for producing a garnet-type oxide solid electrolyte according to the present disclosure includes obtaining the first garnet-type oxide solid electrolyte by heating the above intermediate at 1050 to 1150 °C for 1 to 3 hours and then cooling the intermediate to room temperature within 1 hour. The heating in the heating/cooling step can be performed using a known firing furnace for use in the production of solid electrolytes. The treatment of the intermediate at 1050 to 1150 °C for 1 to 3 hours is intended to remove impurities such as lithium carbonate and lithium hydroxide present in the intermediate.

The heating temperature in the above heating/cooling step is 1050 to 1150 °C. The heating time in the heating/cooling step is 1 to 3 hours. The heating temperature of 1050 °C or more and the heating time of 1 hour or more lead to sufficient removal of impurities from the above LLZO powder intermediate. The heating temperature of 1150 °C or less and the heating time of 3 hours or less reduce energy consumption due to continued heating, thereby leading to reduction in the production cost of the production method of the present disclosure.

The LLZO powder intermediate subjected to the above heat treatment is cooled to room temperature within 1 hour to become the first garnet-type oxide solid electrolyte. The room temperature is 5 to 35 °C. The cooling is performed, for example, by taking the LLZO powder intermediate subjected to the heat treatment out of the firing furnace and leaving it in a dry chamber or a glove box described later to cool it to room temperature within 1 hour. The first garnet-type oxide solid electrolyte obtained by the production method of the present disclosure that includes the heating/cooling step having the above combination of the heating temperature, the heating time, and the cooling time has high ionic conductivity.

### 3) Contact Step

The method for producing the second garnet-type oxide solid electrolyte according to the present disclosure includes obtaining the second garnet-type oxide solid electrolyte by bringing at least one selected from an organic plastic ionic crystal and an ionic liquid (hereinafter sometimes referred to as “organic plastic ionic crystal etc.”) into contact with the above first garnet-type oxide solid electrolyte. The above organic plastic ionic crystal etc. can form an ionic conduction path. By bringing the above organic plastic ionic crystal etc. into contact with the first garnet-type oxide solid electrolyte, the internal resistance and the interface resistance of the second garnet-type oxide solid electrolyte are reduced. By bringing the above organic plastic ionic crystal etc. into contact with the first garnet-type oxide solid electrolyte, the second garnet-type oxide solid electrolyte is coated with the organic plastic ionic crystal etc. This suppresses the formation of lithium carbonate on the surface of the first garnet-type oxide solid electrolyte. As a result, the second garnet-type oxide solid electrolyte is a garnet-type oxide solid electrolyte having high ionic conductivity. From the viewpoint of coating the surface of the first garnet-type oxide solid electrolyte, it is preferable to bring the organic plastic ionic crystal into contact. Bringing the organic plastic ionic crystal into contact with the first garnet-type oxide solid electrolyte leads to obtaining a second garnet-type oxide solid electrolyte having higher ionic conductivity.

The method for achieving the above contact between the first garnet-type oxide solid electrolyte and the organic plastic ionic crystal etc. is not particularly limited as long as the first garnet-type oxide solid electrolyte can be impregnated with the organic plastic ionic crystal etc. Examples of the method for achieving the above contact include a method of immersing the first garnet-type oxide solid electrolyte in the organic plastic ionic crystal etc. and a method of dripping the organic plastic ionic crystal etc. onto the first garnet-type oxide solid electrolyte.

The above organic plastic ionic crystal is not particularly limited as long as it is a known organic plastic ionic crystal that can be applied to lithium secondary batteries. Examples of the organic plastic ionic crystal include aliphatic quaternary ammonium salts consisting of perfluoro anions, such as N,N-diethyl-N-methyl-N-propylammonium trifluoromethyl trifluoroborate (N_{2,2,1,3}[BF₃CF₃]) analogs and N-ethyl-N-methyl-pyrrolidinium bisfluorosulfonylamide (Py_{1,2}[FSA]) analogs. From the viewpoint of electrochemical stability, the organic plastic ionic crystal is preferably N_{2,2,1,3}[BF₃CF₃].

The above ionic liquid is not particularly limited as long as it is a known ionic liquid that can be applied to lithium secondary batteries. Examples of the ionic liquid include N-methyl-N-propylpyrrolidinium bisfluorosulfonylamide (Py_{1,3}[FSA]), N-methyl-N-propylpyrrolidinium bis(trifluoromethylsulfonylamide) (Py_{1,3}[TFSA]), and N-ethyl-N-methylimidazolium bisfluorosulfonylamide (JEMI[FSA]). From the viewpoint of electrochemistry, the ionic liquid is preferably Py_{1,3}[FSA].

Each step in the method for producing a garnet-type oxide solid electrolyte according to the present disclosure can be performed in a dry chamber or a glove box. In particular, it is preferable that the heating/cooling step and the contact step be performed in the dry chamber. This suppresses the formation of lithium carbonate or lithium hydroxide on the surface of the first garnet-type oxide solid electrolyte due to a reaction between the first garnet-type oxide solid electrolyte and carbon dioxide or water. It is preferable that the environment in the dry chamber or the glove box be that the dew point is −50 °C or less.

### EXAMPLES

Next, the invention of the present disclosure will be described in more detail based on examples, but the invention of the present disclosure is not limited to only these examples.

### 1. Raw Materials Used

### LLZO Powder

LLZO powder A: median diameter (D50) of 0.1 μm
LLZO powder B: median diameter (D50) of 0.1 μm
LLZO powder: median diameter (D50) of 1 μm (produced by Toshima Manufacturing Co., Ltd.)
LLZO powder: median diameter (D50) of 10 μm (produced by Toshima Manufacturing Co., Ltd.)

### Obtainment of LLZO Powder A having Median Diameter (D50) of 0.1 μm

A LLZO isopropanol suspension was prepared by pulverizing LLZO powder having a median diameter (D50) of 8.9 μm (produced by Daiichi Kigenso Kagaku Kogyo Co., Ltd.) in isopropanol using a bead mill (Easynano (RMB type) (manufactured by Aimex Co., Ltd.)) with ZrO₂ having a medium particle size of 00.1 mm. The LLZO powder A having the median diameter (D50) of 0.1 μm was obtained by removing isopropanol from the LLZO isopropanol suspension using an evaporator.

### Obtainment of LLZO Powder B Having Median Diameter (D50) of 0.1 μm

A LLZO isopropanol suspension was prepared by pulverizing the above LLZO powder having the median diameter (D50) of 1 μm (produced by Toshima Manufacturing Co., Ltd.) in isopropanol using the bead mill (Easynano (RMB type) (manufactured by Aimex Co., Ltd.)) with ZrO₂ having a medium particle size of 00.1 mm. The LLZO powder B having the median diameter (D50) of 0.1 μm was obtained by removing isopropanol from the LLZO isopropanol suspension using the evaporator.

### 2. Pressure Molding Step

### 1 ) Obtainment of Intermediate 1

An intermediate 1 was obtained by charging 0.075 to 0.15 g of the LLZO powder A having the median diameter (D50) of 0.1 μm into a powder molding machine having a bore diameter of 10 mm in a dry chamber with a dew point of −50 °C or less and then performing uniaxial pressure molding on the LLZO powder having the median diameter (D50) of 0.1 μm at 433 MPa using a hydraulic press. The diameter of the intermediate 1 is 10 mm.

### 2) Obtainment of Intermediate 2

An intermediate 2 was produced using the LLZO powder B having the median diameter (D50) of 0.1 μm. The intermediate 2 was obtained through a process performed by the same method as that for the obtainment of the above intermediate 1 , except that the LLZO powder B having the median diameter (D50) of 0.1 μm was used instead of the LLZO powder A having the median diameter (D50) of 0.1 μm. The diameter of the intermediate 2 is 10 mm.

### 3) Obtainment of Intermediate 3

An intermediate 3 was produced using the LLZO powder having the median diameter (D50) of 1 μm. The intermediate 3 was obtained through a process performed by the same method as that for the obtainment of the above intermediate 1 , except that the LLZO powder having the median diameter (D50) of 1 μm was used instead of the LLZO powder A having the median diameter (D50) of 0.1 μm. The diameter of the intermediate 3 is 10 mm.

### 4) Obtainment of Intermediate 4

An intermediate 4 was produced using the LLZO powder having the median diameter (D50) of 10 μm. The intermediate 4 was obtained through a process performed by the same method as that for the obtainment of the above intermediate 1 , except that the LLZO powder having the median diameter (D50) of 10 μm was used instead of the LLZO powder A having the median diameter (D50) of 0.1 μm. The diameter of the intermediate 4 is 10 mm.

### 3. Heating/Cooling Step

### 1 ) Obtainment of First Garnet-Type Oxide Solid Electrolyte 1

A first garnet-type oxide solid electrolyte 1 was obtained by treating the above intermediate 1 using a firing furnace under the above condition in the dry chamber by methods described later in “Effect of heating temperature on ionic conductivity when cooling time is 4 hours (4 hours or more)” and “Effect of heating temperature on ionic conductivity when cooling time is 1 hour (1 hour or less).” The diameter of the first garnet-type oxide solid electrolyte 1 is 10 mm.

### 2) Obtainment of First Garnet-Type Oxide Solid Electrolyte 2

A first garnet-type oxide solid electrolyte 2 was produced using the above intermediate 2. The first garnet-type oxide solid electrolyte 2 was obtained through a process performed by the method described in “Effect of heating temperature on ionic conductivity when cooling time is 1 hour (1 hour or less)” for “Obtainment of garnet-type oxide solid electrolyte 1,” except that the above intermediate 2 was used. The diameter of the first garnet-type oxide solid electrolyte 2 is 10 mm.

### 3) Obtainment of First Garnet-Type Oxide Solid Electrolyte 3

A first garnet-type oxide solid electrolyte 3 was produced using the above intermediate 3. The first garnet-type oxide solid electrolyte 3 was obtained through a process performed by the same method as that for “Obtainment of garnet-type oxide solid electrolyte 1,” except that the above intermediate 3 was used. The diameter of the first garnet-type oxide solid electrolyte 3 is 10 mm.

### 4) Obtainment of First Garnet-Type Oxide Solid Electrolyte 4

A first garnet-type oxide solid electrolyte 4 was produced using the above intermediate 4. The first garnet-type oxide solid electrolyte 4 was obtained through a process performed by the method described in “Effect of heating temperature on ionic conductivity when cooling time is 4 hours (4 hours or more)” for “Obtainment of garnet-type oxide solid electrolyte 1 ,” except that the above intermediate 4 was used. The diameter of the first garnet-type oxide solid electrolyte 4 is 10 mm.

### 4. Measurement of Ionic Conductivity

To measure the ionic conductivity, a Li symmetric cell 1 using the first garnet-type oxide solid electrolyte 1 was produced. In the Li symmetric cell 1, the first garnet-type oxide solid electrolyte 1 is sandwiched between two lithium disks (diameter of 8 to 9 mm) at a pressure of about 1.5 N·m. The ionic conductivity was measured by an alternating current impedance method. The conditions for measuring the alternating current impedance were an amplitude of 10 to 100 mV and a scanning frequency of 32 MHz to 10 μHz. A Li symmetric cell 2 was produced using the first garnet-type oxide solid electrolyte 2. The Li symmetric cell 2 was produced through the same process as that for the Li symmetric cell 1, except that the first garnet-type oxide solid electrolyte 2 was used instead of the first garnet-type oxide solid electrolyte 1. A Li symmetric cell 3 was produced using the first garnet-type oxide solid electrolyte 3. The Li symmetric cell 3 was produced through the same process as that for the Li symmetric cell 1, except that the first garnet-type oxide solid electrolyte 3 was used instead of the first garnet-type oxide solid electrolyte 1. A Li symmetric cell 4 was produced using the first garnet-type oxide solid electrolyte 4. The Li symmetric cell 4 was produced through the same process as that for the Li symmetric cell 1, except that the first garnet-type oxide solid electrolyte 4 was used instead of the first garnet-type oxide solid electrolyte 1. The ionic conductivities of the first garnet-type oxide solid electrolyte 2, the first garnet-type oxide solid electrolyte 3, and the first garnet-type oxide solid electrolyte 4 were measured by the same measurement method as that for the above first garnet-type oxide solid electrolyte 1 using the Li symmetric cell 2, the Li symmetric cell 3, and the Li symmetric cell 4 instead of the Li symmetric cell 1.

### 5. Effect of Heating Temperature on Ionic Conductivity When Cooling Time Is 4 Hours (4 Hours or More)

1) Obtainment of First Garnet-Type Oxide Solid Electrolytes 1 (4 Hours or More) Different in Heating Temperatures With Cooling Time of 1 hour (4 Hours or More)

A first garnet-type oxide solid electrolyte 1 (800 °C, 4 hours or more) was obtained by a heating/cooling step in which the intermediate 1 was heated at a heating temperature of 800 °C for a heating time of 2 hours using a firing furnace under the above condition in the dry chamber and then cooled to room temperature in the firing furnace for 4 hours. A first garnet-type oxide solid electrolyte 1 (900 °C, 4 hours or more) was obtained by a heating/cooling step in which the intermediate 1 was heated at a heating temperature of 900 °C for a heating time of 2 hours using a firing furnace under the above condition in the dry chamber and then cooled to room temperature in the firing furnace for 4 hours. A first garnet-type oxide solid electrolyte 1 (1000 °C, 4 hours or more) was obtained by a heating/cooling step in which the intermediate 1 was heated at a heating temperature of 1000 °C for a heating time of 2 hours using a firing furnace under the above condition in the dry chamber and then cooled to room temperature in the firing furnace for 4 hours. A first garnet-type oxide solid electrolyte 1 (1100 °C, 4 hours or more) was obtained by a heating/cooling step in which the intermediate 1 was heated at a heating temperature of 1100 °C for a heating time of 2 hours using a firing furnace under the above condition in the dry chamber and then cooled to room temperature in the firing furnace for 4 hours.

### 2) Obtainment of Garnet-Type Oxide Solid Electrolytes 3 (4 Hours or More) and 4 (4 Hours or More) Different in Heating Temperatures With Cooling Time of 4 Hours (4 Hours or More)

Using the intermediate 3, a first garnet-type oxide solid electrolyte 3 (800 °C, 4 hours or more), a first garnet-type oxide solid electrolyte 3 (900 °C, 4 hours or more), a first garnet-type oxide solid electrolyte 3 (1000 °C, 4 hours or more), and a first garnet-type oxide solid electrolyte 3 (1100 °C, 4 hours or more) different in heating temperatures were obtained by the same method as that for “Obtainment of garnet-type oxide solid electrolytes 1 different in heating temperatures with cooling time of 4 hours (4 hours or more),” except that the intermediate 3 was used instead of the intermediate 1. Similarly, a first garnet-type oxide solid electrolyte 4 (800 °C, 4 hours or more), a first garnet-type oxide solid electrolyte 4 (900 °C, 4 hours or more), a first garnet-type oxide solid electrolyte 4 (1000 °C, 4 hours or more), and a first garnet-type oxide solid electrolyte 4 (1100 °C, 4 hours or more) different in heating temperatures were obtained using the intermediate 4.

### 3) Check on Effect of Heating Temperature on Ionic Conductivity When Cooling Time is 4 Hours (4 Hours or More)

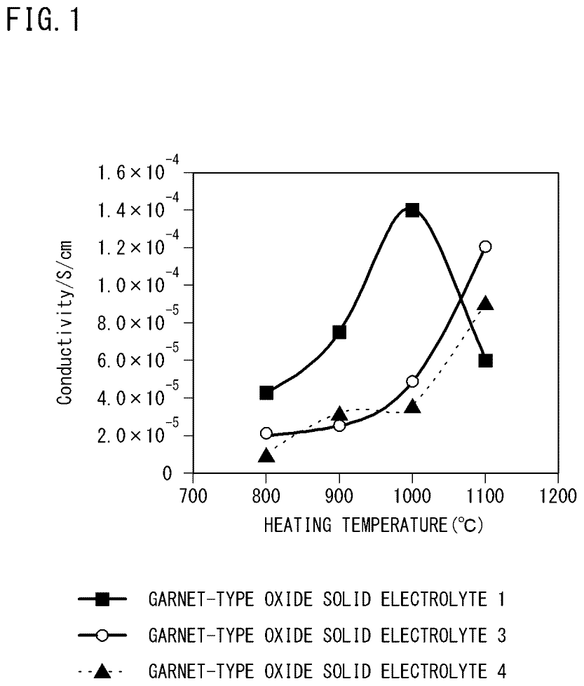

FIG. 1 shows the results of measurement of ionic conductivities of the above first garnet-type oxide solid electrolytes 1 (4 hours or more), 3 (4 hours or more), and 4 (4 hours or more) different in heating temperatures with the cooling time of 4 hours (4 hours or more). FIG. 1 shows that, when the heating temperature is 800 to 1000 °C, the ionic conductivities of the first garnet-type oxide solid electrolytes 1 (4 hours or more), 3 (4 hours or more), and 4 (4 hours or more) tend to increase. However, FIG. 1 shows that, when the heating temperature is 1000 °C or more, the ionic conductivity of the first garnet-type oxide solid electrolyte 1 (4 hours or more) decreases unlike the first garnet-type oxide solid electrolytes 3 (4 hours or more) and 4 (4 hours or more). It is experimentally shown that, when the heating temperature is 1100 °C, the ionic conductivity of the first garnet-type oxide solid electrolyte 1 (4 hours or more) (about 6.0×10⁻⁵ S/cm) is significantly lower than the ionic conductivity of the first garnet-type oxide solid electrolyte 3 (4 hours or more) (about 1.2×10⁻⁴ S/cm) and the ionic conductivity of the first garnet-type oxide solid electrolyte 4 (4 hours or more) (about 9.0×10⁻⁵ S/cm).

### 6. Effect of Heating Temperature on Ionic Conductivity When Cooling Time Is 1 Hour (1 Hour or Less)

### 1) Obtainment of First Garnet-Type Oxide Solid Electrolytes 1 ( 1 Hour or Less) Different in Heating Temperatures With Cooling Time of 1 Hour (1 Hour or Less)

A first garnet-type oxide solid electrolyte 1 (800 °C, 1 hour or less), a first garnet-type oxide solid electrolyte 1 (900 °C, 1 hour or less), a first garnet-type oxide solid electrolyte 1 (1000 °C, 1 hour or less), and a first garnet-type oxide solid electrolyte 1 (1100 °C, 1 hour or less) different in heating temperatures were obtained by the same method as that for “Obtainment of first garnet-type oxide solid electrolytes 1 different in heating temperatures with cooling time of 4 hours (4 hours or more),” except that the cooling time is 1 hour (1 hour or less) instead of 4 hours (4 hours or more).

### 2) Obtainment of Garnet-Type Oxide Solid Electrolytes 2 (1 Hour or Less) and 3 (1 Hour or Less) Different in Heating Temperatures With Cooling Time of 1 Hour (1 Hour or Less)

Using the intermediate 2, a first garnet-type oxide solid electrolyte 2 (800 °C, 1 hour or less), a first garnet-type oxide solid electrolyte 2 (900 °C, 1 hour or less), a first garnet-type oxide solid electrolyte 2 (1000 °C, 1 hour or less), and a first garnet-type oxide solid electrolyte 2 (1100 °C, 1 hour or less) different in heating temperatures were obtained by the same method as that for “Obtainment of garnet-type oxide solid electrolytes 1 different in heating temperatures with cooling time of 1 hour (1 hour or less),” except that the intermediate 2 was used instead of the intermediate 1. Similarly, a first garnet-type oxide solid electrolyte 3 (800 °C, 1 hour or less), a first garnet-type oxide solid electrolyte 3 (900 °C, 1 hour or less), a first garnet-type oxide solid electrolyte 3 (1000 °C, 1 hour or less), and a first garnet-type oxide solid electrolyte 3 (1100 °C, 1 hour or less) different in heating temperatures were obtained using the intermediate 3.

### 3) Check on Effect of Heating Temperature on Ionic Conductivity When Cooling Time is 1 Hour (1 Hour or Less)

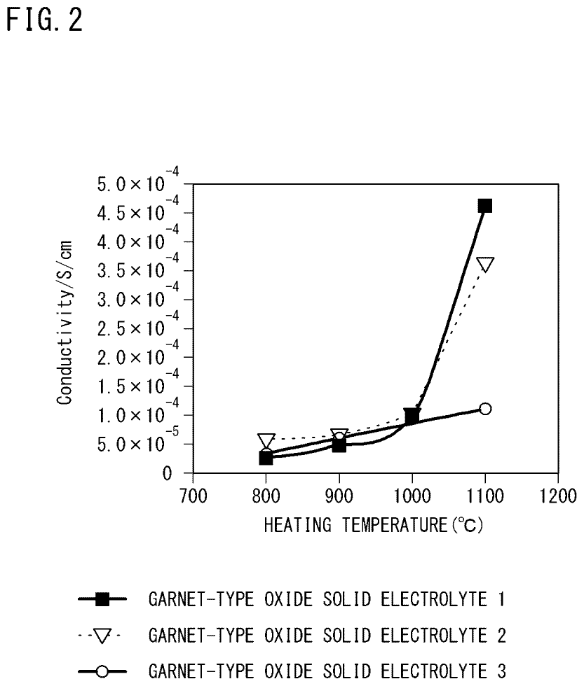

FIG. 2 shows the results of measurement of ionic conductivities of the above first garnet-type oxide solid electrolytes 1 to 3 different in heating temperatures with the cooling time of 1 hour (1 hour or less). FIG. 2 shows that, when the heating temperature is 800 and 900 °C, the first garnet-type oxide solid electrolytes 1 to 3 show approximately the same increase in the ionic conductivity. FIG. 2 shows that the ionic conductivities of the first garnet-type oxide solid electrolytes 1 and 2 increase significantly when the heating temperature is 1000 °C or more. It is experimentally shown that, when the heating temperature is 1100 °C, the ionic conductivity of the first garnet-type oxide solid electrolyte 1 (about 4.5×10⁻⁴ S/cm) and the ionic conductivity of the first garnet-type oxide solid electrolyte 2 (about 3.5×10⁻⁴ S/cm) are significantly higher than the ionic conductivity of the first garnet-type oxide solid electrolyte 3 (about 1.0×10⁻⁴ S/cm).

The first garnet-type oxide solid electrolytes 1 and 2 are the first garnet-type oxide solid electrolytes produced using the LLZO powders having the median diameters (D50) of 0.1 μm and 0.1 μm, respectively. The first garnet-type oxide solid electrolytes 3 and 4 are the first garnet-type oxide solid electrolytes produced using the LLZO powders having the median diameters (D50) of 1 μm and 10 μm, respectively. According to FIGS. 1 and 2, the effects of the heating temperature on the ionic conductivities of the first garnet-type oxide solid electrolytes 1 and 2 differ between the case where the cooling time is 4 hours (4 hours or more) and the case where the cooling time is 1 hour (1 hour or less). More specifically, at the heating temperature of 1000 °C or more, the ionic conductivities of the first garnet-type oxide solid electrolytes 1 and 2 decrease when the cooling time is 4 hours (4 hours or more), and increase when the cooling time is 1 hour (1 hour or less). In particular, at the heating temperature of 1100 °C, the ionic conductivities of the first garnet-type oxide solid electrolytes 1 and 2 are significantly lower than the ionic conductivity of the first garnet-type oxide solid electrolyte 3 when the cooling time is 4 hours (4 hours or more), and are significantly higher than the ionic conductivity of the first garnet-type oxide solid electrolyte 3 when the cooling time is 1 hour (1 hour or less). From this, it is experimentally suggested that, when the heating temperature is 1050 to 1150 °C and the cooling time to room temperature is 1 hour or less, the first garnet-type oxide solid electrolyte produced using the LLZO powder having the median diameter (D50) of 0.02 to 0.2 μm has a significantly higher ionic conductivity than the first garnet-type oxide solid electrolyte produced using the LLZO powder having the median diameter (D50) of 1 μm or more.

1. A method for producing a garnet-type oxide solid electrolyte, the method comprising:
obtaining an intermediate by pressure molding of Li₇La₃Zr₂O12 powder having a median diameter (D50) of 0.02 to 0.2 μm; and
obtaining a first garnet-type oxide solid electrolyte by heating the intermediate at 1050 to 1150 °C for 1 to 3 hours and then cooling the intermediate to room temperature within 1 hour.

2. The method for producing the garnet-type oxide solid electrolyte according to claim 1, further comprising obtaining a second garnet-type oxide solid electrolyte by bringing at least one selected from an organic plastic ionic crystal and an ionic liquid into contact with the first garnet-type oxide solid electrolyte.

3. The method for producing the garnet-type oxide solid electrolyte according to claim 1, wherein the intermediate is obtained by the pressure molding of the Li₇La₃Zr₂O 12 powder under a condition of 72 MPa or more.
